(19) United States
(12) Patent Application Publication
(10) Pub. No.: US 2017/0200396 A1
(43) Pub. Date: Jul. 13, 2017

(54) Crowdsourcing User Generated Content Using Accessibility Enhancements

(71) Applicant: Google Inc., Mountain View, CA (US)

(72) Inventor: Luc Vincent, Palo Alto, CA (US)

(73) Assignee: Google Inc., Mountain View, CA (US)

(21) Appl. No.: 14/091,379

(22) Filed: Nov. 27, 2013

Related U.S. Application Data
(60) Provisional application No. 61/908,503, filed on Nov. 25, 2013.

(51) Int. Cl. G09B 21/00

(52) U.S. Cl. CPC G09B 21/006

(57) ABSTRACT

Systems and methods for crowdsourcing geographic images and other information for use in a geographic information system are provided. Geographic images and other useful information can be crowdsourced from users via an accessibility platform. More particularly, a vision-impaired person can capture an image of a geographic area and submit the image to an accessibility platform to get information associated with the image in audio format spoken to the vision-impaired person in close to real time. The image and other information submitted to the accessibility platform can be used to update a geographic information system.

### PRIORITY CLAIM

This application claims the benefit of priority of U.S. Provisional Patent Application Ser. No. 61/908503, entitled “Crowdsourcing User Generated Content Using Accessibility Enhancements” filed on Nov. 25, 2013.

### FIELD

The present disclosure relates generally to accessibility platforms, and more particularly, to crowdsourcing data for geographic information systems using an accessibility platform.

### BACKGROUND

Geographic information systems provide for the archiving, retrieving, and manipulating of data that has been stored and indexed according to geographic coordinates of its elements. A geographic information system generally includes a variety of data types, including imagery, maps, tables, vector data (e.g. vector representations of roads, parcels, buildings, etc.), three-dimensional models, and other data. Improvements in computer processing power and broadband technology have led to the development of interactive geographic information systems that allow for the navigating and displaying of geographic imagery, such as map imagery, satellite imagery, aerial imagery, panoramic imagery, three-dimensional models, and other geographic imagery. Users can use a geographic information system to search for, view, receive travel directions to, and otherwise navigate a particular geographic area of interest. Geographic information systems are preferably updated periodically with new information (e.g. new images, new three-dimensional models, new data, etc.) so that the geographic information system can provide a current and accurate representation of the world.

Accessibility platforms can allow a vision impaired user to obtain information about a scene. For instance, a user can capture an image of the scene and can submit the image to the accessibility platform. Content depicted in the scene (e.g. text, landmarks, objects, etc.) can be identified. The content can be converted to an audio format. The content in audio format can then be read back or otherwise provided to the user so that the vision-impaired user can gain information about the scene.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of crowdsourcing data for a geographic information system. The method includes receiving, by one or more computing devices, a request associated with an image captured of a geographic area. Responsive to the request, the method can include analyzing, by the one or more computing devices, the image to identify content associated with the image. The method can further include generating, by the one or more computing devices, an audio representation of the content and outputting, by the one or more computing devices, an audio representation of the content. The method can further include updating, by the one or more computing devices, the geographic information system based at least in part on the image captured of the geographic area.

Other aspects of the present disclosure are directed to systems, apparatus, tangible, non-transitory computer-readable media, user interfaces and devices for crowdsourcing information for a geographic information system.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an overview of an example accessibility platform according to an example embodiment of the present disclosure;

FIG. 2 depicts a flow diagram of an example method for crowdsourcing information for a geographic information system according to an example embodiment of the present disclosure;

FIG. 3 depicts an example image provided as part of a request for content according to an example embodiment of the present disclosure;

FIG. 4 depicts a flow diagram of an example method for identifying content associated with one or more features in an image according to an example embodiment of the present disclosure; and

FIG. 5 depicts an example computing system for crowdsourcing information for a geographic information system according to an example embodiment of the present disclosure.

### DETAILED DESCRIPTION

Reference now will be made in detail to embodiments of the invention, one or more examples of which are illustrated in the drawings. Each example is provided by way of explanation of the embodiments, not limitation of the invention. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, example aspects of the present disclosure are directed to systems and methods for crowdsourcing geographic imagery data and other information for use in a geographic information system. Geographic information systems can endeavor to provide an increasingly accurate and current representation of the world. Given the massive volume of information available in certain geographic information systems, it can be costly and time consuming to gather images and other information for keeping the geographic information system current. User generated content, such as photographs of geographic areas captured by a user, can be particularly useful in enhancing the information stored and indexed in a geographic information system.

According to example aspects of the present disclosure, geographic images and other useful information can be crowdsourced from users via an accessibility platform. More particularly, an application implemented on a user device (e.g. a smartphone) can allow a vision-impaired person to capture an image of a scene and to get information back in audio format spoken to the vision-impaired person in close to real time. Unlike a typical accessibility platform, the image and other information generated by the user is not discarded. Rather, the information is used to update the geographic information system. As a result, a two-way data exchange is established between the user and the system.

More specifically, a user can capture an image of a scene using an image capture device and can send the image as part of a request to an accessibility platform for content associated with the captured image. The accessibility platform can analyze the image to identify content associated with the image. The content can include textual data depicted in the image and/or can include information associated with one or more points of interest identified in the image. Once the content has been identified, the accessibility platform can generate an audio representation of the content. The audio representation can be provided to the user device where the audio representation of the content can be read to the user.

The image captured of the scene sent as part of a request to the accessibility platform can be used to update a geographic information system. For instance, the image can be used to construct at least a part of an interactive representation (e.g. an interactive three-dimensional model, an interactive panorama, etc.) of a geographic area in the geographic information system. Alternatively and/or in addition, the identified content associated with the geographic image can be used to enhance the data associated with the geographic information system. For instance, content associated with one or more points of interest depicted in the image can be used to enrich data associated with the one or more points of interest in the geographic information system.

As an example, a vision impaired person can capture with a smartphone an image associated with a geographic area, such as an image of a storefront from a perspective at or near ground level. The image can be associated with geographic coordinates determined, for instance, by a positioning system associated with the smartphone. The image and associated geographic coordinates can be provided to the accessibility platform over a network. The accessibility platform can analyze the image to identify text in the image, such as text on signage associated with the storefront. The identified text can be converted to audio format and provided to the smartphone as an audio file. The smartphone can then play the audio file for the user so that the user can receive information about the geographic area depicted in the image, namely the content of the text on the signage associated with the storefront.

The image, identified text, and/or the associated geographic position can be used to update the geographic information system. For instance, the image can be used to update an interactive panorama depicting the storefront. The text identified in the image can be associated with the storefront in the geographic information system. The geographic position associated with the image can be used to update and/or verify geographic positions of points of interest in the geographic information system.

The information used to update the geographic information system can also be used by the accessibility platform to enhance the functionality and response time of the accessibility platform. For example, the identified text in the image can be associated with particular geographic coordinates in a geographic information system and accessed by the accessibility platform for use in identifying text in future requests. In this way, the two-way data exchange between the accessibility platform and the user provided by example aspects the present disclosure not only enhances the information associated with the geographic information system, but also the user experience with the accessibility platform.

### Example System for Crowdsourcing Data for a Geographic Information System

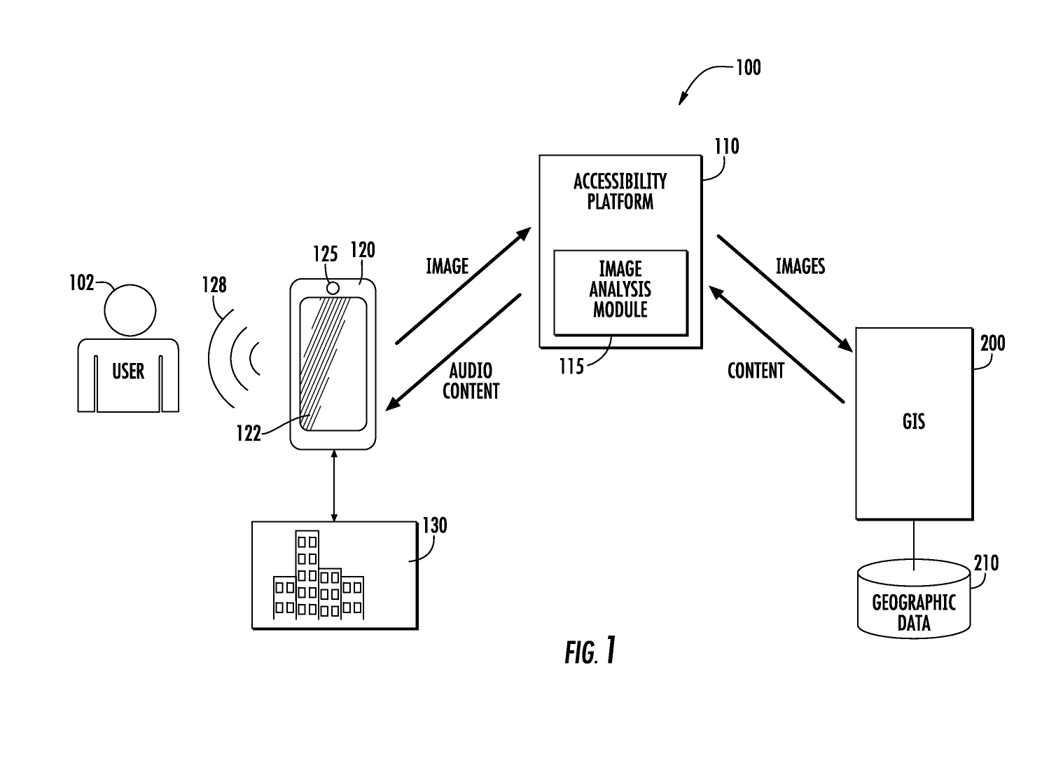

FIG. 1 depicts an overview of an example system 100 for crowdsourcing information for a geographic information system according to an example embodiment of the present disclosure. The system 100 can include an accessibility platform 110. The accessibility platform 110 can be any program, system, or service that allows a user 102, such as a vision-impaired user, to obtain information associated with a scene or object. The accessibility platform 110 can be implemented or hosted by any suitable computing device, such as a web server.

The user 102 can interact with the accessibility platform 110 and other components of the system 100 with a user device 120. The user device 120 can be any suitable computing device, such as a smartphone, tablet, laptop, desktop, wearable computing device, display with one or more processors, or other computing device. The user device 120 can be in communication with the other components of the system 100 over a network (e.g. the Internet). The user device 120 can include a display 122 and/or other suitable input/output devices (e.g. microphone for voice recognition, speakers, etc.) to allow a user to interact with the user device 120. The user device 120 can include one or more image capture devices 125, such as a digital camera.

The user 102 can request information from the accessibility platform 110 by first capturing an image 130 of a scene or other object. The image 130 of the scene or other object can be captured, for instance, using the image capture device 125 of the user device 120 in response to suitable voice commands or other user commands. The image 130 can depict various objects and/or features, such as roads, buildings, monuments, businesses, store fronts, signage, textual data (e.g. a menu), and/or other information. The image 130 can have metadata indicating the geographic location of the image. The metadata can be manually provided by a user or determined, for instance, using a positioning system.

The user 102 can send a request to the accessibility platform 110 for content associated with the image 130. In response to the request, the accessibility platform 110 can implement an image analysis module 115. The image analysis module 115 can be configured to analyze the image to identify content. For instance, the image analysis module 115 can identify text presented in the image using text recognition techniques. In addition and/or in the alternative, features can be identified in the image using feature recognition techniques. Content associated with the features can then be accessed using, for instance a search application. In particular embodiments, the content associated with the features can be identified from data stored or indexed in a geographic information system 200.

Once content associated with the image 130 has been identified, the accessibility platform 110 can convert the content to audio format. For instance, the accessibility platform 110 can convert textual information into an audio file using text-to-speech conversion techniques. The accessibility platform 115 can then provide the audio content 128 to the user device 120 where the user device can play the audio content 128 for the user 102.

In exchange for receiving information associated with the image 130, the user 102 can provide consent for use of the image 130 and any associated metadata (e.g. geographic position information) by the system 100, for instance, to update a geographic information system 200. In situations in which the systems and methods discussed herein access and analyze personal information about users, or make use of personal information, such as user generated images and associated metadata, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

The geographic information system 200 can provide for the archiving, retrieving, and manipulation of geospatial data that has been indexed and stored according to geographic coordinates, such as latitude, longitude, and altitude coordinates, associated with the geospatial data. The geographic information system 200 can combine satellite imagery, aerial imagery, panoramic imagery, street level imagery, photographs, maps, three-dimensional models, vector data and other geographic data, and search capability so as to enable a user to view imagery of a geographic area and related geographic information (e.g., locales such as islands and cities; and points of interest such as local restaurants, hospitals, parks, hotels, and schools). The system 200 can further allow the user to conduct local searches and to get travel directions to a location or between two or more locations. Results can be displayed in a two-dimensional (2D), two-and-half dimensional (2.5D), or three-dimensional (3D) representation of the area of interest. The user can pan, tilt, zoom, and rotate the view to navigate a representation of the area of interest or the view can provide an animated tour around the area of interest.

The geographic information system 200 can include or can be in communication with one or more databases 210. The one or more databases 210 can store geospatial data to be served or provided in response to requests for information provided to the geographic information system 200. The one or more databases 210 can include image data (e.g. digital maps, satellite images, aerial photographs, street level imagery, etc.), non-image data such as tabular data (e.g. digital yellow and white pages), map layer data (e.g. databases of diners, restaurants, museums, and/or schools; databases of seismic activity; database of national monuments; etc.) and other information.

According to example aspects of the present disclosure, the data in the one or more databases 210 can be updated based at least in part the image 130 submitted to the accessibility platform 110. For example, the image 130 can be used to construct or improve interactive three-dimensional models of a geographic area and/or interactive panoramic imagery or other imagery of the geographic area. In addition, content associated with the image identified by the accessibility platform 110 can also be used enrich data associated with geographic information system 200. For instance, content associated with one or more points of interest depicted in the image can be used to add or enhance data associated with points of interest in the geographic information system. In one example implementation of the present disclosure, the audio content 128 generated by the accessibility platform 110 can be associated with a point of interest in the geographic information system 200 so that geographic information system 200 can provide information in audio format.

### Example Method for Crowdsourcing Data for a Geographic Information System

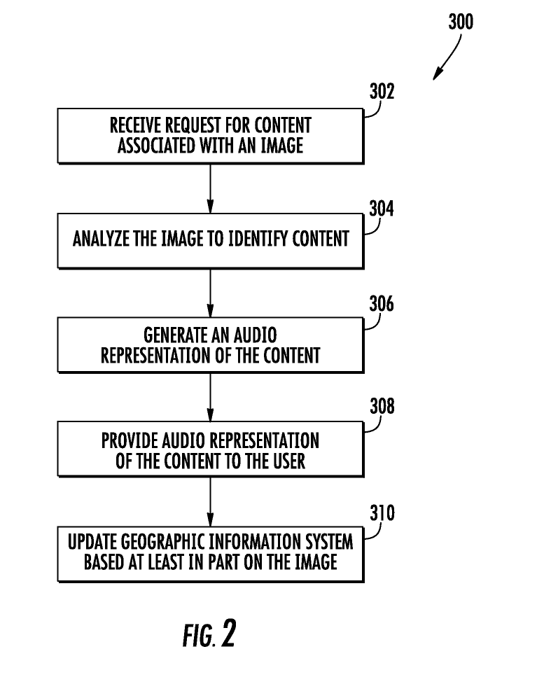

FIG. 2 depicts an example method (300) for crowdsourcing data for a geographic information system according to an example embodiment of the present disclosure. The method (300) can be implemented by one or more computing devices, such as one or more of the computing device depicted in FIG. 5. In addition, FIG. 2 depicts steps performed in a particular order for purposes of illustration and discussion. Those of ordinary skill in the art, using the disclosures provided herein, will understand that the various steps of any of the methods disclosed herein can be modified, adapted, rearranged, omitted, or expanded in various ways without deviating from the scope of the present disclosure.

At (302), the method includes receiving a request for content associated with an image of a geographic area. For instance, the accessibility platform 110 of FIG. 1 can receive a request from a user device 110 for content associated with an image 130 captured by the user device 110. The request for content can be provided in any suitable format. For instance, the request can include the image and any associated metadata, such as geographic location information associated with image. The image can depict one or more features or objects. The features can include, for example, text data, buildings, streets, roads, monuments, or other suitable features.

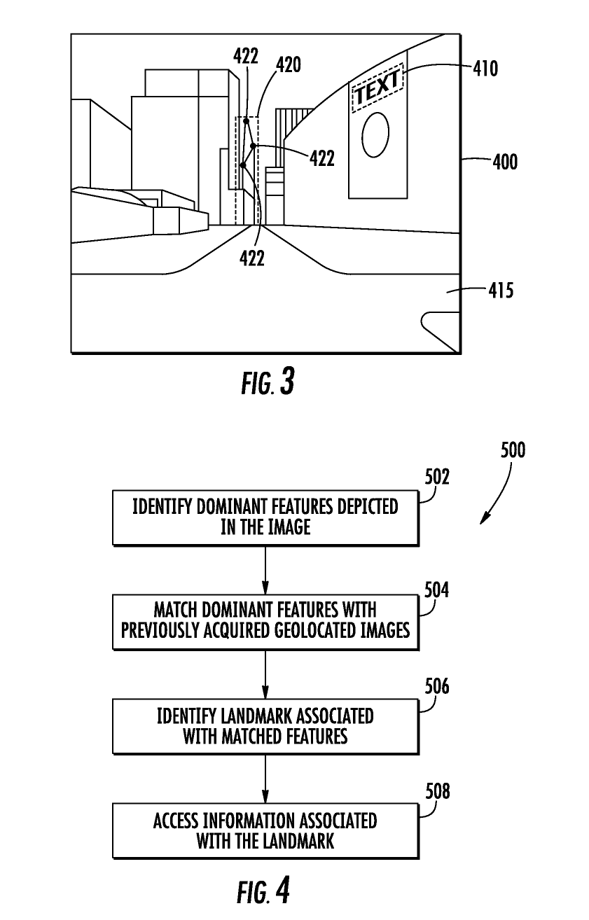

FIG. 3 depicts one example image 400 that can be received as part of a request for content provided to an accessibility platform. The image 400 can be captured by a suitable image capture device, such as an integrated digital camera on a smartphone or wearable computing device. As shown, the image 400 depicts at least a portion of a geographic area. Various features can be depicted in the image 400. These features can include text content 410, street 415, point of interest 420, and other features.

The request can seek audio content associated with one or more features depicted in the image. For instance, the request can seek an audio representation of any text depicted in the image. Alternatively and/or in addition, the request can seek information associated with one or more features depicted in the image, such as the names of businesses depicted in the image, an address of a building depicted in the image, information associated with a point of interest depicted in the image, a menu of a restaurant depicted in the image, a street name of a street depicted in the image, a phone number and store hours of a business depicted in the image, etc.

Referring back to FIG. 2 at (304), the method can include analyzing the image to identify content associated with the image. For instance, the image analysis module 115 of FIG. 1 can analyze image 130 received by the accessibility platform 110 to identify content associated with the image 130. The identified content can include text content depicted in the image and/or can include information associated with one or more features or objects depicted in the image.

More particularly, in one example implementation of the present disclosure, the image is analyzed to identify text content in the image. For example, image analysis techniques can be performed on the image 400 of FIG. 3 to identify text content 410. Text content can be identified from the image using any suitable text recognition technique, such as optical character recognition techniques or optical word recognition techniques. The text recognition techniques can include identifying patterns in the image and matching those patterns to characters or text.

In another example implementation of the present disclosure, the image can be analyzed to identify content associated with one or more features or objects depicted in the image. The information can be identified, for example, using a visual search application that is configured to analyze the image to identify various features or points of interest and to search for content (e.g. online content or content in a geographic information system) associated with the features or points of interest.

Referring to the example image 400 of FIG. 3, feature identification techniques can be used to identify point of interest 420 in the image 400. Information relating to point of interest 420 can then be obtained, for instance, using a search engine or by accessing information associated with the point of interest stored in a geographic information system. The information relating to the point of interest 420 can be extracted as content associated with the image.

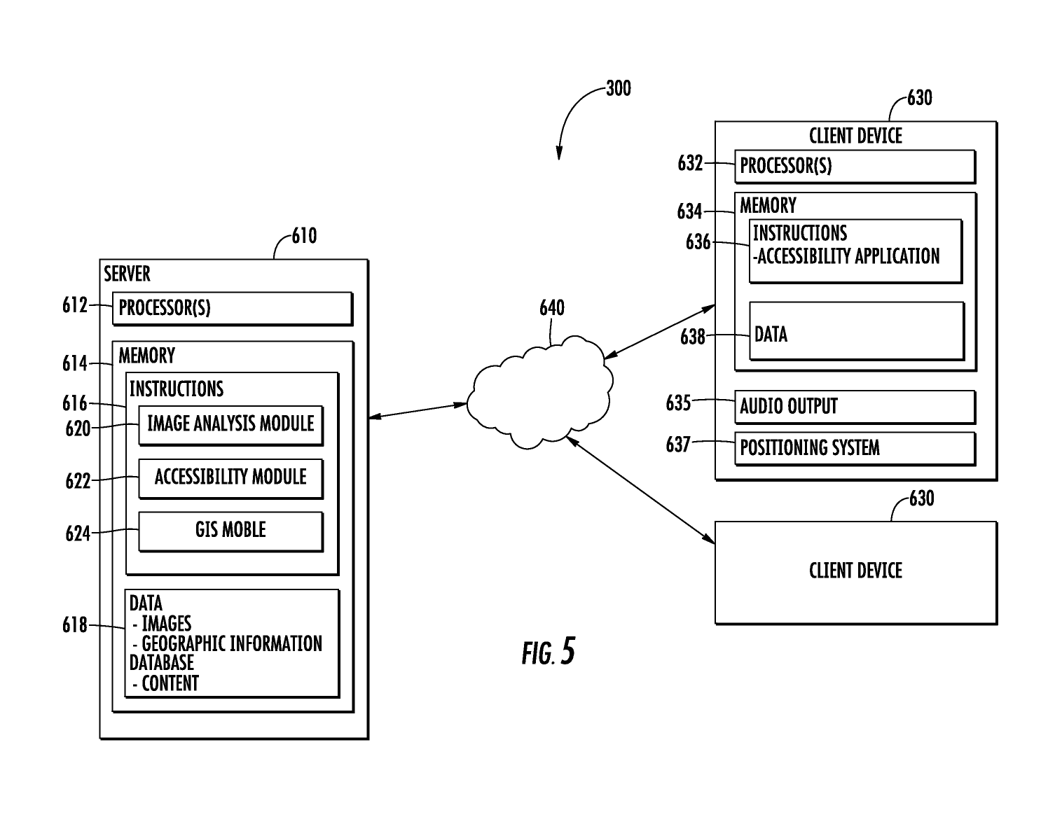

FIG. 4 depicts a flow diagram of an example method (500) for identifying content associated with one or more features depicted in an image according to an example embodiment of the present disclosure. FIG. 4 illustrates one example technique for identifying content associated with an image. Those of ordinary skill in the art, using the disclosures provided herein, will understand that other suitable techniques can be used to identify content without deviating from the scope of the present disclosure.

At (502), one or more dominant features depicted in the image can be identified. The dominant features can be portions of the image identified using feature detection techniques. Feature detection techniques search the image for locations that are distinctive. Any suitable technique can be used for feature detection. For example, image processing techniques can analyze image gradients to identify distinctive features in each of the plurality of images. Referring to the example image 400 of FIG. 3, points 422 can be identified as dominant features in the image 400.

At (504) of FIG. 4, the identified dominant features can be matched against one or more previously geolocated images stored, for instance, in a geographic information system or database of information. For instance, points 422 of FIG. 3 can be matched with corresponding features in previously geolocated imagery of the geographic area. The dominant features can be matched using suitable feature matching techniques. Feature matching techniques compare the detected features in the images to determine groups of features that correspond to some fixed point in the scene depicted by the captured images. The features can be matched, for instance, based on appearance or based on feature similarity. In one particular implementation, a rudimentary clustering of the data points into point clusters can be performed to facilitate matching of the features. In particular implementations, metadata providing position information associated with the image can be used as part of the feature matching process. For instance, the position information can be used to narrow a search window for matched features in previously geolocated imagery.

At (506) of FIG. 4, one or more points of interest associated with the matched features can be identified. For instance, the matched features in the previously geolocated imagery can be associated with one or more points of interest in a database. The database can be accessed to match the features with the associated points of interest. For example, points 422 of FIG. 3 can be associated with building 420 in the geographic information system. Building 420 can be identified as a point of interest associated with the points 422 depicted in the image 400.

Information associated with the point of interest can then be accessed or obtained as shown at (508) of FIG. 4. For example a search engine can locate information available online associated with point of interest. Alternatively and/or in addition, information associated with the known landmark or point of interest can be extracted from the geographic information system or other database of information.

Referring back to FIG. 2, once the content associated with the image has been identified, the method can include generating an audio representation of the content as shown at (306). For example, text content can be converted to audio content using suitable text-to-speech conversion techniques. Similarly, content associated with one or more features depicted in the image can be converted to an audio format. Any suitable audio format can be used without deviating from the scope of the present disclosure, such as a digital audio format. At (308), the system can output the audio content, for instance, to the user. For instance, the accessibility platform 110 of FIG. 1 can provide the audio content to the user device 120. The user device 120 can then play the audio content to the user 102.

At (310) of FIG. 2, the method includes updating a geographic information system based at least in part on the image of the geographic area received as part of the request. The geographic information system can be updated based at least in part on the image in various ways. In one example aspect, the image can be used to construct or improve representations of the geographic area provided by the geographic information system. For instance, the image can be used to improve an interactive three-dimensional model of the geographic area. The image can be used to update interactive panoramas or other imagery of the geographic area. In addition, the image can be stored and indexed by geographic position in the geographic information system so that the image itself can be accessed by a user of the geographic information system. In this manner, the geographic information system can provide user generated content obtained using an accessibility platform.

Any content associated with the image can also be used to update the geographic information system. For instance, text content (e.g. signage, menus, etc.) identified by the accessibility platform can be associated with points of interest in the geographic information system. Users of the geographic information system can then access the text content by browsing or searching for information associated with the point of interest in the geographic information system.

In a particular implementation, the audio content associated with the image generated by the accessibility platform can be used to enrich data associated with the geographic information system. More specifically, audio content associated with a point of interest or feature depicted in the image can be associated with the point of interest or feature in the geographic information system. A user can access then access the audio content when browsing or searching for information about the point of interest in the geographic information system.

As demonstrated by the above examples, a geographic information system can be updated in various ways based at least in part on the image received as part of a request for content provided to an accessibility platform. The above examples are presented for purposes of illustration and discussion and are not intended to limit the scope of the present disclosure.

### Example Computing System for Crowdsourcing Data for a Geographic Information System

FIG. 5 depicts a computing system 600 that can be used to implement the methods and systems according to example aspects of the present disclosure. The system 600 can be implemented using a client-server architecture that includes a server 610 that communicates with one or more client devices 630 over a network 640. The system 600 can be implemented using other suitable architectures, such as a single computing device.

The system 600 includes a server 610, such as a web server. The server 610 can host one or more of an accessibility platform and/or a geographic information system. The server 610 can be implemented using any suitable computing device(s). The server 610 can have one or more processors 612 and memory 614. The server 610 can also include a network interface used to communicate with one or more client devices 630 over a network 640. The network interface can include any suitable components for interfacing with one more networks, including for example, transmitters, receivers, ports, controllers, antennas, or other suitable components.

The one or more processors 612 can include any suitable processing device, such as a microprocessor, microcontroller, integrated circuit, logic device, or other suitable processing device. The memory 614 can include any one or more computer-readable media, including, but not limited to, non-transitory computer-readable media, RAM, ROM, hard drives, flash drives, or other memory devices. The memory 614 can store information accessible by the one or more processors 612, including instructions 616 that can be executed by the one or more processors 612. The instructions 616 can be any set of instructions that when executed by the one or more processors 612, cause the one or more processors 612 to provide desired functionality. For instance, the instructions 616 can be executed by the one or more processors 612 to implement one or more modules, such as an image analysis module 620, an accessibility module 622, and a geographic information system (GIS) module 624.

The image analysis module 620 can be configured to analyze an image and to identify content associated with the image. For instance, the image analysis module 620 can be configured to identify text content in an image or to identify content associated with one or more features depicted in the image using, for instance, the method (500) of FIG. 4. The accessibility module 622 can be configured to implement one or more aspects of an accessibility platform, including converting the content identified by the image analysis module 620 to an audio representation of the content. The GIS module 624 can be configured to implement one or more aspects of a geographic information system. The GIS module 624 can be configured to update data associated with the geographic information system based at least in part on an image received as part of a request for content associated with the image.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media. When software is used, any suitable programming language or platform can be used to implement the module.

Memory 614 can also include data 618 that can be retrieved, manipulated, created, or stored by the one or more processors 612. The data 618 can include images provided to an accessibility platform, content associated with the images, geographic information data, and other data. The data 618 can be stored in one or more databases. The one or more databases can be connected to the server 610 by a high bandwidth LAN or WAN, or can also be connected to server 610 through network 640. The one or more databases can be split up so that they are located in multiple locales.

The server 610 can exchange data with one or more client devices 630 over the network 640. Although two client devices 630 are illustrated in FIG. 5, any number of client devices 630 can be connected to the server 610 over the network 640. The client devices 630 can be any suitable type of computing device, such as a general purpose computer, special purpose computer, laptop, desktop, mobile device, smartphone, tablet, wearable computing device, a display with one or more processors, or other suitable computing device.

Similar to the server 610, a client device 630 can include one or more processor(s) 632 and a memory 634. The one or more processor(s) 632 can include one or more central processing units (CPUs), graphics processing units (GPUs) dedicated to efficiently rendering images, and/or other processing devices. The memory 634 can include one or more computer-readable media and can store information accessible by the one or more processors 632, including instructions 636 that can be executed by the one or more processors 632 and data 638. For instance, the memory 634 can store instructions 636 for implementing an accessibility application that allows a vision impaired user to obtain audio content associated with a captured image.

The client device 630 of FIG. 5 can include various input/output devices for providing and receiving information from a user, such as a touch screen, touch pad, data entry keys, speakers, and/or a microphone suitable for voice recognition. For instance, the client device 530 can have an audio output 635 for presenting audio content to a user.

The client device 630 can further include a positioning system 637. The positioning system 637 can be any device or circuitry for determining the position of a client device. For example, the positioning system 637 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

The client device 630 can also include a network interface used to communicate with one or more remote computing devices (e.g. server 610) over the network 640. The network interface can include any suitable components for interfacing with one more networks, including for example, transmitters, receivers, ports, controllers, antennas, or other suitable components.

The network 640 can be any type of communications network, such as a local area network (e.g. intranet), wide area network (e.g. Internet), wireless network, cellular network, or some combination thereof. The network 640 can also include a direct connection between a client device 630 and the server 610. In general, communication between the server 610 and a client device 630 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of crowdsourcing data for a geographic information system, the method comprising:
receiving, by one or more computing devices associated with an accessibility platform configured to provide information to a vision-impaired user, a request associated with an image captured of a geographic area;
responsive to the request, analyzing, by the or more computing devices associated with the accessibility platform, the image to identify content associated with the image, the content associated with the image comprising one or more features depicted within the image;
generating, by the one or more computing devices associated with the accessibility platform, an audio representation of the content;
providing, by the one or more computing devices associated with the accessibility platform, for output the audio representation of the content; and
providing, by the one or more computing devices associated with the accessibility platform, data associated with the image and content identified by the accessibility platform for updating the geographic information system based at least in part on the image captured of the geographic area and the audio representation of the content associated with the image.

2. (canceled)

3. (canceled)

4. The computer-implemented method of claim 1, wherein the content associated with the image is identified based at least in part on information stored in the geographic information system.

5. The computer-implemented method of claim 1, wherein outputting, by the one or more computing devices, the audio representation of the content comprises communicating, by the one or more computing devices, the audio representation of the content to a user device for presentation to a user.

6. The computer-implemented method of claim 1, wherein the content associated with the image comprises text data in the image.

7. The computer-implemented method of claim 1, wherein analyzing, by the one or more computing devices, the image to identify content comprises:
identifying, by the one or more computing devices, a feature depicted in the image;
matching, by the one or more computing device, the feature with previously geolocated imagery of the geographic area;
identifying, by the one or more computing devices, a point of interest associated with the feature; and
obtaining content associated with the point of interest.

8. The computer-implemented method of claim 1, wherein the image comprises metadata providing a geographic location associated with the image.

9. The computer-implemented method of claim 8, wherein the geographic information system is updated based at least in part on the metadata providing the geographic position associated with the image.

10. The computer-implemented method of claim 9, wherein updating the geographic information system comprises associating the content with the geographic position in the geographic information system.

11. The computer-implemented method of claim 1, wherein the image is used to generate an interactive representation of the geographic area.

12. The computer-implemented method of claim 10, wherein the interactive representation is an interactive three-dimensional model or an interactive panorama.

13-20. (canceled)
